(19) United States
(12) Patent Application Publication
(10) Pub. No.: US 2024/0426696 A1
(43) Pub. Date: Dec. 26, 2024

(54) METHOD FOR EVALUATING SERVICE PERFORMANCE OF TRANSPORTATION INFRASTRUCTURE HEALTH MONITORING SYSTEMS AND DEVICE THEREFOR

(71) Applicant: Research Institute of Highway Ministry of Transport, Beijing (CN)

(72) Inventors: Lu Peng, Beijing (CN); Yu Tang, Beijing (CN); Xiaofan Feng, Beijing (CN); Guangwu Dou, Beijing (CN); Pengfei Li, Beijing (CN); Bin Li, Beijing (CN); Genqiang Jing, Beijing (CN)

(21) Appl. No.: 18/545,671

(22) Filed: Dec. 19, 2023

(30) Foreign Application Priority Data
Jun. 20, 2023 (CN) 2023107309424

(51) Int. Cl. G01M 5/00

(52) U.S. Cl. CPC G01M 5/0008; G01M 5/0066

(57) ABSTRACT

A method for evaluating the service performance of transportation infrastructure health monitoring systems and a device therefor. The method includes: placing the provided external incentive within the road section monitored by the transportation infrastructure health monitoring system to be evaluated; obtaining feedback data corresponding to the external incentive acting within the road section through the standard sensor; constructing a predictive response model of the feedback data within the road section, and combining the predictive response model with the feedback data to obtain predicted data; obtaining measured data through the transportation infrastructure health monitoring system to be evaluated; conducting an evaluation and a calibration on service performance of the transportation infrastructure health monitoring system to be evaluated based on the predicted data and the measured data. It achieves the effectiveness evaluation of transportation infrastructure monitoring systems and reduces the demand for human and material resources during evaluation process.

### CROSS-REFERENCE

This application claims to the benefit of priority from Chinese Application No. 202310730942.4 with a filing date of Jun. 20, 2023. The content of the aforementioned applications, including any intervening amendments thereto, are incorporated herein by reference.

### TECHNICAL FIELD

The present disclosure relates to the field of service performance evaluation and calibration of transportation infrastructure health monitoring systems, in particular to a method for evaluating service performance of transportation infrastructure health monitoring systems and a device therefor.

### BACKGROUND

The current methods for evaluating the service performance of transportation infrastructure health monitoring systems mainly include the following two methods:

1. Conduct measurement performance evaluation of health monitoring systems based on fixed loads. At present, fixed weight vehicles are used to apply loads to the bridge to realize fixed and dynamic loads, and the effectiveness of the monitoring system measurement is evaluated using the stress-strain-displacement principle.

2. Online calibration method for the equal strength cantilever beam. The equal strength cantilever beam is composed of a base, an equal strength cantilever beam, and weights. A monitoring system is arranged parallel to the cantilever beam, after adding the weights, the beam is deformed caused by the weight of the weights, and then the output value of the monitoring system is collected. And after a certain period of time, adding or reducing the number of the weights, at the same time, two sets of monitoring data sequence values are recorded, and the feature points are matched to calibrate the sequence data.

No matter which method mentioned above, most of them have the disadvantage of consuming a lot of manpower and material resources. At the same time, the evaluation method for the effectiveness of monitoring system measurement using fixed loads has high requirements for loads, and faces related problems such as traffic congestion caused by the need to close the road during each load test period.

### SUMMARY

In response to the deficiencies of existing technology and the demand of practical applications, the present disclosure provides a method for evaluating the service performance of transportation infrastructure health monitoring systems, aiming to achieve the effectiveness evaluation of the transportation infrastructure monitoring system in a non-invasive manner and reduce the demand for human and material resources during the evaluation process. A method for evaluating service performance of transportation infrastructure health monitoring systems, including the following steps: providing external incentives and setting the external incentive within a road section monitored by the transportation infrastructure health monitoring system to be evaluated; providing a standard sensor, and obtaining feedback data corresponding to the external incentive acting within the road section through the standard sensor; constructing a predictive response model of the feedback data within the road section, and combining the predictive response model with the feedback data to obtain predicted data; obtaining measured data through the transportation infrastructure health monitoring system to be evaluated; conducting an evaluation and a calibration on the service performance of the transportation infrastructure health monitoring system to be evaluated based on the predicted data and the measured data.

The method for evaluating the service performance of the transportation infrastructure health monitoring systems provided by the present disclosure predicts the response data of the corresponding road section by constructing a response model of external incentives and corresponding road sections, combined with the measured data obtained from the standard sensor, and compares it with the actual data obtained from the transportation infrastructure health monitoring system to be evaluated, thereby achieving the evaluation and calibration of the current service performance of the transportation infrastructure health monitoring system to be evaluated. The present disclosure not only saves manpower and material resources, but also improves the selectivity of external incentives by constructing response models for various external incentives and corresponding road sections, overcoming the load requirements in the current service performance evaluation of transportation infrastructure health monitoring system. At the same time, the method for evaluating the service performance of the transportation infrastructure health monitoring system provided by the present disclosure is an online measurement scheme, which can achieve timely data resource updates and corresponding system evaluation and calibration. The online measurement method does not need to close roads, which can effectively avoid traffic congestion and other related problems caused by closed roads.

Optionally, the step of providing the external incentive and setting the external incentive within the road section monitored by the transportation infrastructure health monitoring system to be evaluated includes the following steps: providing a vehicle with four degrees of freedom as the external incentive; setting a motion speed of the vehicle with four degrees of freedom; placing the vehicle with four degrees of freedom within the road section monitored by the transportation infrastructure health monitoring system to be evaluated, wherein the vehicle with four degrees of freedom travels at a constant speed at the motion speed.

Optionally, the step of constructing the predictive response model of the feedback data within the road section, and combining the predictive response model with the feedback data to obtain the predicted data includes the following steps: constructing a vehicle vertical motion equation based on an interaction between the vehicle with four degrees of freedom and the road section; constructing the vehicle vertical displacement equation by utilizing the vehicle vertical motion equation; solving the vehicle vertical displacement equation to obtain a relationship between the vertical displacement of the vehicle and the bridge modal displacement; obtaining a relationship between a vehicle vertical acceleration and a bridge oscillation frequency response by utilizing the relationship between the vertical displacement of the vehicle and the bridge modal displacement; obtaining the predictive response model by utilizing the relationship between the vehicle vertical acceleration and the bridge oscillation frequency response.

Optionally, the predictive response model satisfies the following formula:

$${a}_{c} = {\sum }_{n} \frac{{Δ}_{stn}}{( 1 - {S}_{n}^{2} )} \{ {( 2 D )}^{2} cos 2 D +$$

$${S}_{n} [ {( {ω}_{bn} - D )}^{2} cos ( {ω}_{bn} - D ) t - {( {ω}_{bn} + D )}^{2} cos ( {ω}_{bn} - D ) t ] \} ,$$

wherein, a_{c} denotes the vehicle vertical acceleration, Δₛₜₙ denotes the static load displacement, Sₙ denotes the vehicle dynamic response coefficient parameter, n=1, 2, 3, . . . , n denotes the number of orders of the bridge frequency,

$$D = \frac{n π v}{L} ,$$

ν denotes the vehicle speed ignoring damping, L denotes the length of the road section of a bridge,

$${ω}_{bn} = \frac{{n}^{2} {π}^{2}}{{L}^{2}} \sqrt{\frac{EI}{\overline{m}}} ,$$

ω_{bn} is the n-th order frequency of bridge oscillation, mi denotes the unit mass of the bridge, E denotes the elastic modulus of the bridge, I denotes the moment of inertia of the cross section of the bridge, and t denotes the vehicle running time.

Optionally, the step of obtaining the measured data through the transportation infrastructure health monitoring system to be evaluated includes the following steps: obtaining an actual measurement data sequence through the transportation infrastructure health monitoring system to be evaluated; generating a first-order measurement data sequence by utilizing the actual measurement data sequence; building a prediction coefficient model based on the actual measurement data sequence and the first-order measurement data sequence, and using the prediction coefficient model to obtain the prediction coefficient; generating a first-order measurement prediction sequence by combining the first-order measurement data sequence with the corresponding prediction coefficient; generating an raw data prediction sequence by combining the first-order measurement prediction sequence with the actual measurement data sequence.

Optionally, the raw data prediction sequence satisfies the following model: \hat{X}⁰={\hat{x}⁰(1), \hat{x}⁰(2), . . . , \hat{x}⁰(G)}, wherein, \hat{X}⁰ denotes the raw data prediction sequence, G denotes the total number of sample data in the raw data prediction sequence, \hat{x}⁰(1)=\hat{x}⁰ (1), \hat{x}⁰(i)=\hat{x}¹(i)−\hat{x}¹(i−1), \hat{x}⁰(1) denotes the first sample data in the raw data prediction sequence, \hat{x}⁰(1) denotes the first sample data in the actual measurement data sequence, \hat{x}⁰(i) denotes the i-th sample data in the raw data prediction sequence, \hat{x}¹(i) denotes the i-th sample data in the first-order measurement prediction sequence, and \hat{x}¹(i−1) denotes the i−1-th sample data in the first-order measurement prediction sequence.

Optionally, the step of obtaining measured data through the transportation infrastructure health monitoring system to be evaluated further includes correcting the first-order measurement prediction sequence, wherein correcting the first-order measurement prediction sequence includes the following steps: combining the raw data prediction sequence with the actual measurement data sequence to obtain a basic absolute error sequence; generating a first-order error data sequence by utilizing the basic absolute error sequence; building an error prediction coefficient model based on the basic absolute error sequence and the first-order error data sequence, and utilizing the error prediction coefficient model to obtain an error prediction coefficient; correcting the first-order measurement prediction sequence by utilizing the error prediction coefficient and the basic absolute error sequence.

Optionally, the corrected first-order measurement prediction sequence satisfies a following model: [symbol] ¹={ [symbol] ¹(1), [symbol] ¹(2), . . . , [symbol] ¹(G)}, wherein

$${1}^{} ( i ) = [ {x}^{0} ( 1 ) - \frac{b}{a} ] {e}^{- a ( i - 1 )} + \frac{b}{a} + ( - {a}_{ε} ) [ {ε}^{0} ( i ) - \frac{{b}_{ε}}{{a}_{ε}} ] {e}^{- {a}_{ε} ( i - 1 )} ,$$

[symbol]

¹ denotes the corrected first-order measurement prediction sequence, i=1, 2, . . . , G, [symbol] ¹(i) denotes the i-th sample data in the corrected first-order measurement prediction sequence, x⁰(1) denotes the first sample data in the actual measurement data sequence, a denotes the first prediction coefficient, b denotes the second prediction coefficient, e denotes the natural constant, a_{ε} denotes the first error prediction coefficient, b_{ε} denotes the second error prediction coefficient, and ε⁰(i) denotes the i-th absolute error data of the basic absolute error sequence.

Optionally, the step of obtaining the measured data through the transportation infrastructure health monitoring system to be evaluated further includes the following steps: building a prediction error model, and utilizing the prediction error model to obtain a prediction error of sample data in the raw data prediction sequence; setting a prediction error threshold, and utilizing the prediction error threshold in combination with the prediction error to correct the sample data in the raw data prediction sequence.

In order to better implement the method for evaluating the service performance of the transportation infrastructure health monitoring systems mentioned above, the present disclosure further provides a device for evaluating the service performance of transportation infrastructure health monitoring systems, aiming to more efficiently and accurately implement the method for evaluating the service performance of the transportation infrastructure health monitoring systems. The device for evaluating service performance of transportation infrastructure health monitoring systems includes a processor, an input device, an output device, and a memory, wherein the processor, the input device, the output device, and the memory are interconnected; the memory is configured to store computer programs, the computer program includes program instructions, and the processor is configured to call the program instructions to execute the method for evaluating service performance of transportation infrastructure health monitoring systems in the first aspect of the present disclosure. The device for evaluating the service performance of transportation infrastructure health monitoring systems provided by the present disclosure has a compact structure, stable performance, and can efficiently execute the method for evaluating the service performance of the transportation infrastructure health monitoring systems of the present disclosure, which to some extent improves the applicability and practical application ability of the present disclosure.

### BRIEF DESCRIPTION OF THE DRAWINGS

FIG. 1 is a flowchart of a method for evaluating service performance of transportation infrastructure health monitoring systems of the present disclosure;

FIG. 2 is a flowchart of the implementation of step S04 provided in the embodiment of the present disclosure;

FIG. 3 is a schematic diagram of the structure of a device for evaluating service performance of transportation infrastructure health monitoring systems of the present disclosure;

FIG. 4 is a schematic diagram of the connection between the service performance device of the transportation infrastructure health monitoring systems of the present disclosure and a plurality of intelligent terminals.

### DETAILED DESCRIPTION OF THE EMBODIMENTS

The specific embodiments of the present disclosure will be described in detail below. It should be noted that the embodiments described here are only for illustrative purposes and are not intended to limit the present disclosure. In the following description, a large number of specific details are elaborated to provide a thorough understanding of the present disclosure. However, it is obvious to ordinary skilled person the art that it is not necessary to used these specific details to implement the present disclosure. In other examples, in order to avoid confusion with the present disclosure, there is no specific description of well-known circuits, software, or methods.

Throughout the entire specification, references to “one embodiment”, “embodiment”, “one example”, or “example” mean that specific features, structures, or characteristics described in conjunction with the embodiment or example are included in at least one embodiment of the present disclosure. Therefore, the phrases “in one embodiment”, “in an embodiment”, “one example”, or “example” appearing throughout the entire specification may not necessarily refer to the same embodiment or example. In addition, specific features, structures, or characteristics can be combined in one or more embodiments or examples in any appropriate combination and/or sub combination. In addition, ordinary skilled person in the art should understand that the illustrations provided here are for illustrative purposes and may not necessarily be drawn to scale.

Most of the existing methods for evaluating the service performance of transportation infrastructure health monitoring systems have the disadvantage of consuming a large amount of manpower and material resources. At the same time, the evaluation method for measuring the effectiveness of monitoring systems using fixed loads requires high load requirements, and faces related problems such as traffic congestion caused by the need to close roads during each load test period. Based on this, this disclosure provides a solution that can solve the above technical problems, and its detailed content will be elaborated in subsequent embodiments.

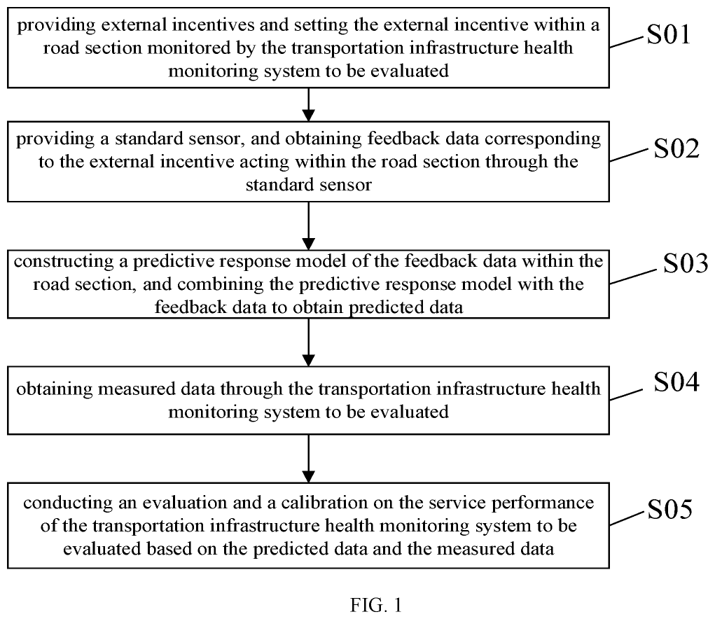

Please refer to FIG. 1, in an optional embodiment, FIG. 1 is a flowchart of the method for evaluating the service performance for the transportation infrastructure health monitoring system provided by the embodiment of the present disclosure. As shown in FIG. 1, the flowchart of the method for evaluating the service performance for the transportation infrastructure health monitoring systems includes the following steps:

S01, providing external incentives, and setting the external incentive within a road section monitored by the transportation infrastructure health monitoring system to be evaluated.

In this embodiment, the external incentive provided in step S01 is a vehicle, which is a vehicle with four degrees of freedom. Specifically, the four degrees of freedom include: forward/backward, left and right translation, rotation, and body tilting. the vehicle with four degrees of freedom can more accurately simulate the real traffic environment, and at the same time, the behavior of the vehicle with four degrees of freedom is easy to be finely controlled, which can simulate different driving styles and traffic flow conditions to evaluate the stability and performance of transportation infrastructure.

Wherein, forward/backward means that the vehicle is capable to move in its forward or backward direction. Left and right translation means the vehicle is capable to move in translation to left or right. Rotation means that the vehicle is capable to rotate around an axis perpendicular to the ground. Body tilting means that the vehicle is capable to tilt in the front and rear directions.

In an optional embodiment, to evaluate the service performance of a bridge structural health monitoring system, the step S01 of providing external incentives, and setting the external incentive within a road section monitored by the transportation infrastructure health monitoring system to be evaluated includes the following steps:

S011, providing a vehicle with four degrees of freedom as the external incentive.

In this embodiment, a vehicle with four degrees of freedom equipped with a powertrain and sensors is provided as external incentives. This vehicle can achieve movements such as forward/backward, left and right translation, rotation, and body tilting, thereby simulating the behavior of vehicles on the bridge.

S012, setting a motion speed of the vehicle with four degrees of freedom.

It can be understood that the present disclosure can simulate the impact of dynamic loads on bridge structures at different vehicle speeds by setting different motion speeds. In this embodiment, the vehicle with four degrees of freedom is set to travel at a constant speed of 50 kilometers per hour.

S013, placing the vehicle with four degrees of freedom within the road section monitored by the transportation infrastructure health monitoring system to be evaluated, wherein the vehicle with four degrees of freedom travels at a constant speed at the motion speed.

In this embodiment, the Step S013 is to place a vehicle with four degrees of freedom on a specific section of the target bridge, which is the bridge road section monitored by the bridge structural health monitoring system, such as the main beam section of the bridge. Then the vehicle is driven at a predetermined speed to simulate the vehicle running on the bridge. This can collect dynamic data related to vehicle travelling and be used for the evaluation of the service performance of the bridge structural health monitoring system in the future.

S02, providing a standard sensor, and obtaining feedback data corresponding to the external incentive acting within the road section through the standard sensor.

It should be understood that standard sensors serve as precise data sources for evaluating and calibrating the service performance of transportation infrastructure health monitoring systems to be evaluated. The selection and setting of standard sensors must ensure the accuracy and timeliness of the obtained data. At the same time, the types of data measured by standard sensors can be set based on the physical properties of external incentive sources in the established predictive response model.

In an optional embodiment, in order to evaluate the service performance of the bridge structural health monitoring system, a corresponding prediction model is constructed using the vertical acceleration and the bridge oscillation frequency response at the contact point between the external incentive sources and the road section. Therefore, the measurement data of the standard sensor can be the vertical acceleration at the contact point between the external incentive sources and the road section, or the vertical displacement at the contact point between the external incentive sources and the road section, which can accurately derive the vertical acceleration properties.

In this embodiment, the step S02 of providing a standard sensor, and obtaining feedback data corresponding to the external incentives acting within the road section through the standard sensor, including the following steps:

S021, providing the standard sensor in the vehicle with four degrees of freedom.

In order to improve the implementation efficiency of the present disclosure, the standard sensor described in the embodiment of the present disclosure is selected as an acceleration sensor. Furthermore, the step S021 of providing the acceleration sensor in the vehicle with four degrees of freedom. It can be understood that this sensor can directly measure the acceleration changes of the vehicle in different directions, including the vertical acceleration.

S022, obtaining the vertical acceleration of the vehicle with four degrees of freedom moving at a constant speed within the road section through the standard sensor.

In this embodiment, the vertical acceleration changes of the vehicle within the bridge road section can be monitored in real-time through the acceleration sensor inside the vehicle.

S03, constructing a predictive response model of the feedback data within the road section, and combining the predictive response model with the feedback data to obtain predicted data.

To evaluate the service performance of bridge structural health monitoring systems, in an optional embodiment, the step S03 of constructing a predictive response model of the feedback data within the road section includes the following steps:

S031, constructing a vehicle vertical motion equation based on the interaction between the vehicle with four degrees of freedom and the road section.

In this embodiment, based on the interaction between the vehicle with four degrees of freedom and the road section, the following vehicle vertical motion equation is established. The vehicle vertical motion equation satisfies the following formula: mᵥüᵥ(t)+kᵥ(uᵥ(t)−u_{c})=0, wherein mᵥ denotes the equivalent mass of the vehicle, uᵥ(t) denotes the vertical displacement function of the vehicle, üᵥ(t) denotes the second-order vertical displacement function of the vehicle, t denotes the vehicle running time, kᵥ denotes the spring support stiffness of the vehicle, u_{c} denotes the initial vertical displacement of the contact point between the vehicle and the road surface.

It can be understood that the second-order vertical displacement function üᵥ(t) is the function obtained from conducting two consecutive derivatives on the vertical displacement function uᵥ(t) of the vehicle. Furthermore, the vertical displacement function can be obtained by fitting based on feedback data.

S032, constructing the vehicle vertical displacement equation by utilizing the vehicle vertical motion equation.

To evaluate the service performance of the bridge structural health monitoring system, the step S032 is combined with the partial differential equation of bridge vibration

$$\overline{m} \ddot{u} ( t ) + EI \frac{{\partial }^{2} u ( t )}{\partial {x}^{2}} = 0$$

to construct the corresponding vertical displacement equation of the vehicle.

Specifically, in this embodiment, the vehicle vertical displacement equation satisfies the following formula:

$$\overline{m} \ddot{u} ( t ) + EI \frac{{\partial }^{2} u ( t )}{\partial {x}^{2}} = {m}_{v} \ddot{{u}_{v}} ( t ) + {k}_{v} ( {u}_{v} ( t ) - {u}_{c} ) ,$$

wherein, m̅ denotes the unit mass of the bridge, E denotes the elastic modulus of the bridge, I denotes the moment of inertia of the bridge section, x denotes the running length of the vehicle, mᵥ denotes the equivalent mass of the vehicle, uᵥ(t) denotes the vertical displacement function of the vehicle, üᵥ(t) denotes the second-order vertical displacement function of the vehicle, t denotes the vehicle running time, and kᵥ denotes the spring support stiffness of the vehicle, u_{c} denotes the initial vertical displacement of the contact point between the vehicle and the road surface.

Furthermore, for the subsequent rapid solution of the vehicle vertical displacement equation to obtain the relationship between the vertical displacement of the vehicle and the bridge modal displacement, in this embodiment, the damping during vehicle running is ignored and the vehicle vertical displacement equation is simplified. The simplified vehicle vertical displacement equation satisfies the following formula:

$$\overline{m} \ddot{u} ( t ) + EI \frac{{\partial }^{2} u ( t )}{\partial {x}^{2}} = [ {k}_{v} ( {u}_{v} ( t ) - {u}_{c} ) - {m}_{v} g ] σ ( x - vt ) ,$$

wherein m̅ denotes the unit mass of the bridge, E denotes the elastic modulus of the bridge, I denotes the moment of inertia of the bridge section, x denotes the length of vehicle running, mᵥ denotes the equivalent mass of the vehicle, uᵥ(t) denotes the vertical displacement function of the vehicle, üᵥ(t) denotes the second-order vertical displacement function of the vehicle, t denotes the vehicle running time, kᵥ denotes the spring support stiffness of the vehicle, u_{c} denotes the initial vertical displacement of the contact point between the vehicle and the road surface, g denotes the acceleration of gravity, σ denotes the Dirac function, and v denotes the running speed of the vehicle without considering damping.

S033, solving the vehicle vertical displacement equation to obtain a relationship between the vertical displacement of the vehicle and the bridge modal displacement.

The step S033 can use existing technology to solve the vehicle vertical displacement equation mentioned above, and then obtain the relationship between the vertical displacement of the vehicle and the bridge modal displacement. In this embodiment, the obtained relationship between the vertical displacement of the vehicle and the bridge modal displacement satisfies the following formula:

$${u}_{v} ( t ) = {\sum }_{n} {u}_{b n} ( t ) sin ( \frac{n π x}{L} ) ,$$

wherein n denotes the number of order of the bridge frequency, u_{bn}(t) denotes the modal displacement function of the bridge, t denotes the vehicle running time, and L denotes the length of the bridge road section.

S034, obtaining a relationship between a vehicle vertical acceleration and a bridge oscillation frequency response by utilizing the relationship between the vertical displacement of the vehicle and the bridge modal displacement.

The step S034 utilized the relationship

$${u}_{v} ( t ) = {\sum }_{n} {u}_{bn} ( t ) sin ( \frac{n π x}{L} )$$

between the vertical displacement of the vehicle and the bridge modal displacement obtained from the step S033 to further construct the corresponding equation for the vertical acceleration of the vehicle

$${a}_{c} = \ddot{{u}_{v}} ( t ) + \frac{{\partial }^{2} \ddot{{u}_{v}} ( t )}{{ω}_{v}^{2} \partial {t}^{2}} ,$$

wherein a_{c} is the vertical acceleration of the vehicle,

$${ω}_{v} = \sqrt{\frac{{k}_{v}}{{m}_{v}}} ,$$

ωᵥ denotes the frequency of the vehicle, kᵥ denotes the spring support stiffness of the vehicle, and mᵥ denotes the equivalent mass of the vehicle.

By substituting the relationship u(t) between the vertical displacement of the vehicle and the bridge modal displacement into the above equation for vehicle

$$vertical {accelerationa}_{c} = \ddot{{u}_{v}} ( t ) = \frac{{\partial }^{2} \ddot{{u}_{v}} ( t )}{{ω}_{v}^{2} \partial {t}^{2}} ,$$

the corresponding vertical acceleration of the vehicle can be obtained. In this embodiment, the vertical acceleration of the vehicle satisfies the following formula:

$${a}_{c} = {\sum }_{n} \frac{{Δ}_{stn}}{( 1 - {S}_{n}^{2} )} \{ {( 2 D )}^{2} cos 2 D +$$

$${S}_{n} [ {( {ω}_{bn} - D )}^{2} cos ( {ω}_{bn} - D ) t - {( {ω}_{bn} + D )}^{2} cos ( {ω}_{bn} - D ) t ] \} ,$$

wherein, a_{c} denotes the relationship between the vertical acceleration of the vehicle and the frequency response of the bridge oscillation, Δₛₜₙ denotes the static load displacement, Sₙ denotes the dynamic response coefficient parameter of the vehicle, n=1, 2, 3, . . . , n denotes the number of order of the bridge frequency,

$$D = \frac{n π v}{L}$$

denotes the running speed of the vehicle without damping, L denotes the length of the bridge road section,

$${ω}_{b n} = \frac{{n}^{2} {π}^{2}}{{L}^{2}} \sqrt{\frac{E I}{\overline{m}}} ,$$

ω_{bn} denotes the n-th order frequency of the bridge oscillation, m̅ denotes the unit mass of the bridge, E denotes the elastic modulus of the bridge, I denotes the moment of inertia of the bridge section, and t denotes the vehicle running time.

S035, obtaining the predictive response model by utilizing the relationship between the vehicle vertical acceleration and the bridge oscillation frequency response.

Due to the vehicle frequency

$${ω}_{v} = \sqrt{\frac{{k}_{v}}{{m}_{v}}} ,$$

the n-th order bridge oscillation frequency

$${ω}_{b n} = \frac{{n}^{2} {π}^{2}}{{L}^{2}} \sqrt{\frac{E I}{\overline{m}}} ,$$

and the expression of the vertical acceleration a_{c} of the vehicle mentioned above, it can be inferred that the vertical acceleration of the contact point is independent of the vehicle frequency. Therefore, in this embodiment, the predicted response model obtained in the step S035 is the relationship between the vertical acceleration of the vehicle and the frequency response of the bridge oscillation:

$${a}_{c} = {\sum }_{n} \frac{{Δ}_{s t n}}{( 1 - {S}_{n}^{2} )} \{ {( 2 D )}^{2} cos 2 D + {S}_{n} [ {( {ω}_{b n} - D )}^{2} cos ( {ω}_{b n} - D ) t - {( {ω}_{b n} + D )}^{2} cos ( {ω}_{b n} - D ) t ] \} .$$

In another optional embodiment, in order to achieve online measurement of the vibration of the bridge main beam, in this embodiment, only the modal frequencies before the 3rd order of the bridge are focused, and the corresponding predicted response model satisfies the following formula:

$${a}_{c} = {\sum }_{n} \frac{{Δ}_{s t n}}{( 1 - {S}_{n}^{2} )} \{ {( 2 D )}^{2} cos 2 D + {S}_{n} [ {( {ω}_{b n} - D )}^{2} cos ( {ω}_{b n} - D ) t - {( {ω}_{b n} + D )}^{2} cos ( {ω}_{b n} - D ) t ] \} ,$$

wherein a also denotes the relationship between the vertical acceleration of the vehicle and the vibration frequency of the bridge, Δₛₜₙ denotes the static load displacement, Sₙ denotes the dynamic response coefficient parameter of the vehicle, n=1, 2, 3, n denotes the number of order of the bridge frequency,

$$D = \frac{n π v}{L} ,$$

v denotes the running speed of vehicle without damping, L denotes the length of the bridge road section,

$${ω}_{b n} = \frac{{n}^{2} {π}^{2}}{{L}^{2}} \sqrt{\frac{E I}{\overline{m}}} ,$$

ω_{bn} denotes the n-th order frequency of bridge oscillation, m̅ denotes the unit mass of the bridge, E denotes the elastic modulus of the bridge, I denotes the moment of inertia of the bridge section, and t denotes the vehicle running time.

Furthermore, the step S03 of combining the predictive response model with the feedback data to obtain predicted data can be demonstrated in this embodiment as substituting the acceleration signal fed back by the acceleration sensor into the constructed predicted response model, corresponding to obtaining predicted data of the bridge oscillation frequency.

S04, obtaining measured data through the transportation infrastructure health monitoring system to be evaluated.

It should be understood that the transportation infrastructure health monitoring system to be evaluated serves as a system for monitoring a series of parameters such as the usage status, behavior, and performance of transportation infrastructure. It includes various types of sensing devices. It can be understood that the data stored in this system also integrates real-time data and historical data from various aspects such as structure, materials, loads, climate, etc.

Principal component analysis is a statistical analysis method used to identify the required measured data. It extracts the main features from the data by reducing its dimensions, achieving the recognition and acquisition of the required data. Therefore, the present disclosure can choose to identify and extract the required feature data from a large amount of measured data by applying principal component analysis.

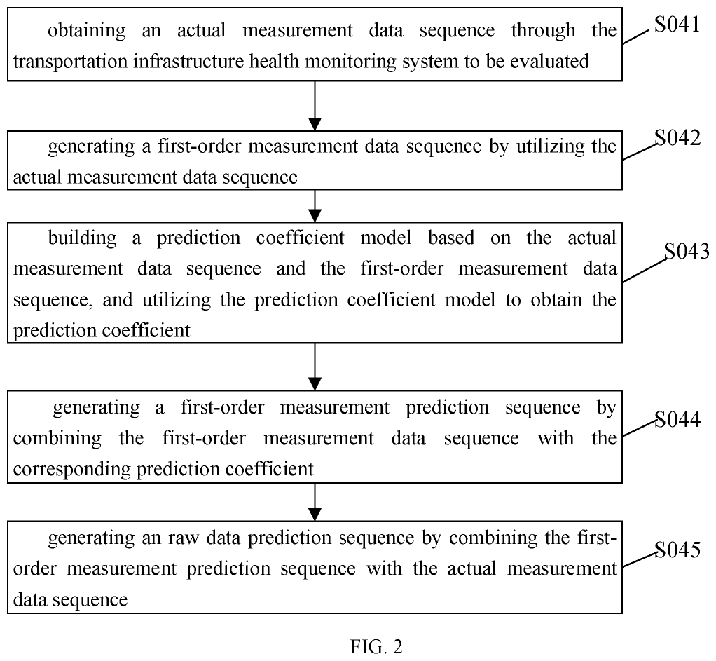

For the above measured data, there are cases of data loss and other factors mentioned above resulting in a small sample of actual measurement data used for evaluation, in order to provide more complete measured data for the subsequent accurate evaluation and calibration of the transport infrastructure health monitoring system, further, in an optional embodiment, please refer to FIG. 2, which shows a flowchart of the implementation of the step S04 provided by an embodiment of the present disclosure. As shown in FIG. 2, the step S04 of obtaining measured data through the transportation infrastructure health monitoring system to be evaluated includes the following steps:

S041, obtaining an actual measurement data sequence through the transportation infrastructure health monitoring system to be evaluated.

The step S041 can use feature recognition techniques such as principal component analysis and machine learning to obtain the required actual measurement data in the data repository of the transportation infrastructure health monitoring system to be evaluated. In this embodiment, to evaluate the service performance of the bridge structural health monitoring system, the actual measurement data sequence obtained in step S041 is the data sequence of bridge vibration collected by the corresponding transportation infrastructure health monitoring system when the vehicle with four degrees of freedom is driving at a constant speed on the corresponding bridge road.

In this embodiment, the actual measurement data sequence satisfies the following model: X⁰={x⁰ (1), x⁰ (2), . . . , x⁰ (G)}, wherein X⁰ denotes the actual measurement data sequence, x⁰(i) denotes the i-th sample data in the actual measurement data sequence, and G denotes the total number of sample data in the actual measurement data sequence.

S042, generating a first-order measurement data sequence by utilizing the actual measurement data sequence.

In this embodiment, the first-order measurement data sequence generated based on the actual measurement data sequence satisfies the following model: X¹={x¹(1), x¹(2), . . . , x¹(G)}, wherein x¹(i)=Σ₁ⁱx⁰(i), i=1, 2, . . . , G, x¹(i) denotes the i-th sample data in the first-order measurement data sequence, and X¹ denotes the first-order measurement data sequence.

Due to the fact that the first-order measurement data sequence is obtained by accumulating the actual measurement data sequence, the G in the above model also denotes the total number of sample data in the first-order measurement data sequence, and the sample data of each first-order measurement data x¹(i) denotes the sum of first i sample data in the actual measurement data sequence.

S043, building a prediction coefficient model based on the actual measurement data sequence and the first-order measurement data sequence, and utilizing the prediction coefficient model to obtain the prediction coefficient.

In this embodiment, based on the least square method, a corresponding prediction coefficient model is constructed through the actual measurement data sequence and first-order measurement data sequence. The prediction coefficient model satisfies the following formula:

$${[ a , b ]}^{T} = {( {B}^{T} B )}^{- 1} {B}^{T} Y , B = [ \begin{matrix}- 0.5 [ {x}^{1} ( 1 ) + {x}^{1} ( 2 ) ] & 1 \\ - 0.5 [ {x}^{1} ( 2 ) + {x}^{1} ( 3 ) ] & 1 \\ ⋮ & ⋮ \\ - 0.5 [ {x}^{1} ( G - 1 ) + {x}^{1} ( G ) ] & 1\end{matrix} ] , Y = {[ {x}^{0} ( 2 ) , {x}^{0} ( 3 ) , … , {x}^{0} ( G ) ]}^{T} ,$$

wherein, a is the first prediction coefficient and b is the second prediction coefficient. Furthermore, by utilizing the specific values of the actual measurement data sequence and the first-order measurement data sequence, combined with the aforementioned prediction coefficient model, the first prediction coefficient α and second prediction coefficient b can be obtained.

S044, generating a first-order measurement prediction sequence by combining the first-order measurement data sequence with the corresponding prediction coefficient.

The first-order measurement prediction sequence generated in step S044 satisfies the following model: \hat{X}¹={\hat{x}¹(1), \hat{x}¹(2), . . . , \hat{x}¹(G)}, wherein,

$${\hat{x}}^{1} ( i ) = [ {x}^{0} ( 1 ) - \frac{b}{a} ] {e}^{- a ( i - 1 )} + \frac{b}{a} ,$$

\hat{x}¹(i) denotes the i-th sample data in the first-order measurement prediction sequence, x⁰(1) denotes the first sample data in the actual measurement data sequence, a denotes the first prediction coefficient, b denotes the second prediction coefficient, e denotes a natural constant, and \hat{X}¹ denotes the first-order measurement prediction sequence.

S045, generating an raw data prediction sequence by combining the first-order measurement prediction sequence with the actual measurement data sequence.

In this embodiment, the raw data prediction sequence generated based on the first-order measurement prediction sequence and the actual measurement data sequence satisfies the following model: \hat{X}⁰={\hat{x}⁰(1), \hat{x}⁰(2), . . . , \hat{x}⁰(G)}, wherein, \hat{X}⁰ denotes the raw data prediction sequence, G denotes the total number of sample data in the raw data prediction sequence, \hat{x}⁰(1)=\hat{x}⁰(1), \hat{x}⁰(i)=\hat{x}¹(i)−\hat{x}¹(i−1), \hat{x}⁰(1) denotes the first sample data in the raw data prediction sequence, \hat{x}⁰(1) denotes the first sample data in the actual measurement data sequence, \hat{x}⁰(i) denotes the i-th sample data in the raw data prediction sequence, \hat{x}¹(i) denotes the i-th sample data in the first-order measurement prediction sequence, and \hat{x}¹(i−1) denotes the i−1-th sample data in the first-order measurement prediction sequence.

In another optional embodiment, error correction is conducted on the first-order measurement prediction sequence to obtain a more accurate raw data prediction sequence. Specifically, in this embodiment, correcting the first-order measurement prediction sequence includes the following steps:

Combining the raw data prediction sequence with the actual measurement data sequence to obtain the basic absolute error sequence. The absolute error sequence satisfies the following model: ε⁰={ε⁰(1), ε⁰(2), . . . , ε⁰(G)}, wherein, ε⁰(i)=|\hat{x}⁰(i)−\hat{x}⁰(i)|, i=1, 2, . . . , G, ε⁰(i) denotes the i-th absolute error data of the basic absolute error sequence, \hat{x}⁰(i) denotes the i-th sample data in the raw data prediction sequence, x⁰(i) denotes the i-th sample data in the actual measurement data sequence, and ε⁰ denotes the basic absolute error sequence. Similarly, G is the total number of sample data in the absolute error sequence.

Generating a first-order error data sequence by utilizing the basic absolute error sequence. The first-order error data sequence satisfies the following formula: ε¹={ε¹(1), ε¹(2), . . . , ε¹(G)}, wherein, ε¹(i)=Σ₁ⁱε⁰(i), i=1, 2, . . . , G, ε¹(i) denotes the i-th sample data in the first-order error data sequence, and ε¹ denotes the first-order error data sequence.

Building an error prediction coefficient model based on the basic absolute error sequence and the first-order error data sequence, and utilizing the error prediction coefficient model to obtain an error prediction coefficient. In this embodiment, the prediction coefficient model satisfies the following formula:

$${[ {a}_{ε} , {b}_{ε} ]}^{T} = {( {B}_{ε}^{T} {B}_{ε} )}^{- 1} {B}_{ε}^{T} {Y}_{ε} , {B}_{ε} = [ \begin{matrix}- 0.5 [ {ε}^{1} ( 1 ) + {ε}^{1} ( 2 ) ] & 1 \\ - 0.5 [ {ε}^{1} ( 2 ) + {ε}^{1} ( 3 ) ] & 1 \\ ⋮ & ⋮ \\ - 0.5 [ {ε}^{1} ( G - 1 ) + {ε}^{1} ( G ) ] & 1\end{matrix} ] , {Y}_{ε} = {[ {ε}^{0} ( 2 ) , {ε}^{0} ( 3 ) , … , {ε}^{0} ( G ) ]}^{T} ,$$

wherein a_{ε} is the first error prediction coefficient, and b_{ε} is the second error prediction coefficient. Furthermore, by utilizing the specific values of the basic absolute error sequence and the first-order error data sequence, combined with the aforementioned error prediction coefficient model, the first error prediction coefficient a_{ε} and the second error prediction coefficient b_{ε} can be obtained.

Correcting the first-order measurement prediction sequence by utilizing the error prediction coefficient and the basic absolute error sequence, and the corrected first-order measurement prediction sequence satisfies the following model: [symbol] ¹={ [symbol] ¹(1), [symbol] ¹(2), . . . , [symbol] ¹(G)}, wherein,

$${{\hat{x}}^{′}}^{1} ( i ) = [ {x}^{0} ( 1 ) - \frac{b}{a} ] {e}^{- a ( i - 1 )} + \frac{b}{a} + ( - {a}_{ε} ) [ {ε}^{0} ( i ) - \frac{{b}_{ε}}{{a}_{ε}} ] {e}^{- {a}_{ε} ( i - 1 )} ,$$

[symbol]

¹ denotes the corrected first-order measurement prediction sequence, i=1, 2, . . . , G, [symbol] ¹ (i) denotes the i-th sample data in the corrected first-order measurement prediction sequence, x⁰(1) denotes the first sample data in the actual measurement data sequence, a denotes the first prediction coefficient, b denotes the second prediction coefficient, e denotes a natural constant, a_{ε} denotes the first error prediction coefficient, b_{ε} denotes the second error prediction coefficient, and ε⁰(i) denotes the i-th absolute error data of the basic absolute error sequence.

In this embodiment, by correcting the first-order measurement prediction sequence, a more accurate raw data prediction sequence is obtained as the measured data obtained in step S04, which is used for the precise evaluation and calibration of subsequent transportation infrastructure health monitoring systems.

It should be understood that the above embodiments are all based on the raw data prediction sequence obtained by the accumulation method. Therefore, as the number of samples increases and the number of accumulations increases, the accuracy of the predicted raw data prediction sequence also decreases. Furthermore, in an optional embodiment, in response to the problem of low prediction accuracy caused by the accumulation method, the step S04 of obtaining measured data through the transportation infrastructure health monitoring system to be evaluated, further including the following steps:

S046, building a prediction error model, and utilizing the prediction error model to obtain a prediction error of sample data in the raw data prediction sequence.

In this embodiment, the prediction error model satisfies the following formula:

$$C = \frac{\sqrt{{{\sum }_{i = 1}^{\sum } [ {ε}^{0} ( i ) - {\overline{ε}}^{0} ]}^{2}}}{\sqrt{{{\sum }_{i = 1}^{\sum } [ {x}^{0} ( i ) - {\overline{x}}^{0} ]}^{2}}} , p = \{ \vert {ε}^{0} ( i ) - {\overline{ε}}^{0} \vert < 0. 6745 \sqrt{\frac{{{\sum }_{i = 1}^{\sum } [ {x}^{0} ( i ) - {\overline{x}}^{0} ]}^{2}}{\sum }} \} ,$$

wherein, C denotes the variance ratio, p denotes the small error probability, i=1, 2, . . . , G, ε⁰(i) denotes the i-th absolute error data in the basic absolute error sequence, 0° denotes the mean of the absolute error data in the basic absolute error sequence, \hat{x}⁰(i) denotes the i-th sample data in the actual measurement data sequence, and x° denotes the average value of the sample data in the actual measurement data sequence.

S047, setting a prediction error threshold, and utilizing the prediction error threshold in combination with the prediction error to correct the sample data in the raw data prediction sequence.

It should be understood that the error threshold refers to the allowable error range set when correcting the raw data prediction sequence, which is based on actual demands and system requirements, and the specific value of the error threshold depends on the specific application scenario and performance requirements of the monitoring system. In this embodiment, the error threshold is the acceptable range of the variance ratio and small error probability between the raw data prediction sequence and the actual measurement data sequence.

In an optional embodiment, based on actual demands and system requirements, there are evaluation criteria expressed in the following table:

| Inspection | The | The | The | The |
|---|---|---|---|---|
| indicators/ | first-level | Second-level | third-level | fourth-level |
| accuracy class | (excellent) | (good) | (average) | (unqualified) |
| Variance ratio C | <0.35 | 0.35-0.50 | 0.50-0.65 | >0.65 |
| Small error | >0.95 | 0.80-0.95 | 0.70-0.80 | <0.70 |
| probability p | | | | |

As shown in the above table, when the variance ratio C obtained by the prediction error model between the sample data in the raw data prediction sequence and the actual measurement data sequence is greater than 0.65 or the small error probability p is less than 0.70, the corresponding sample data will be considered unqualified, on the contrary, it is qualified. For unqualified sample data in the raw data prediction sequence, optimization can be achieved through network models such as Kalman filter neural network model and recurrent neural network model.

In another optional embodiment, due to the fact that the Kalman filter neural network model not only has the regularity of empirical regression prediction, but also has the timeliness of neural network model mapping, a Kalman filter neural network model trained through relevant historical data is selected to correct the unqualified sample data mentioned above. The corrected raw data prediction sequence satisfies the following model: \hat{X}^{0*}={\hat{x}^{0*}(1), \hat{x}^{0*}(2), . . . , \hat{x}^{0*}(G)}, wherein \hat{x}^{0*}(i)=\hat{x}⁰(i)+K(\hat{x}⁰ (i)+z(i)), \hat{x}^{0*}(i) denotes the i-th sample data in the corrected raw data prediction sequence, K denotes the Kalman gain,

$$K = \sqrt{\frac{{Δ}_{m s e}^{P}}{{Δ}_{m s e}^{P} + {Δ}_{m s e}^{o}}} , {Δ}_{m s e}^{P} = \frac{{{\sum }_{1}^{i} [ {\hat{x}}^{0} ( i ) - {x}^{0} ( i ) ]}^{2}}{i} , {Δ}_{m s e}^{o} = \frac{{{\sum }_{1}^{i} [ z ( i ) - {x}^{0} ( i ) ]}^{2}}{i} ,$$

Δₘₛₑ^{P} denotes the raw prediction error, Δₘₛₑ^{o} denotes the observation error, \hat{x}⁰(i) denotes the i-th sample data in the raw data prediction sequence, x⁰(i) denotes the i-th sample data in the actual measurement data sequence, and z(i) denotes the i-th mapping data of the Kalman filter neural network model to the i-th sample data in the actual measurement data sequence.

It should be understood that in step S04, a series of sub steps are taken to address the issues in the measured data obtained through the transportation infrastructure health monitoring system to be evaluated. The processed data not only has the characteristics of the raw measured data, but also facilitates the evaluation and calibration of the transportation infrastructure health monitoring system to be evaluated in the future.

S05, conducting an evaluation and a calibration on the service performance of the transportation infrastructure health monitoring system to be evaluated based on the predicted data and the measured data.

In an optional embodiment, the step of conducting an evaluation and a calibration on the service performance of the transportation infrastructure health monitoring system to be evaluated based on the predicted data and the measured data, including the following steps:

S051, identifying the data consistency between the predicted data and the measured data, or identifying the consistency of the data change trend between the predicted data and the measured data.

S052, evaluating the service performance of the transportation infrastructure health monitoring system to be evaluated through identification results.

S053, utilizing the difference between the predicted data and the measured data, conducting the calibration on the service performance of the transportation infrastructure health monitoring system to be evaluated.

The prediction data obtained from the actual data measured by the standard sensor in the present disclosure, combined with the actual data measured by the health monitoring system of the transportation infrastructure to be evaluated, is used as the measurement correlation between the same measurement quantity to achieve the evaluation of measurement effectiveness and precise calibration between each other.

In another optional embodiment, the transportation infrastructure health monitoring system may include transportation infrastructure health monitoring systems deployed in bridges and tunnels. The transportation infrastructure health monitoring system includes multiple single parameter sensing measurement equipment, as well as data processing devices that communicate with each of the single parameter sensing measurement equipment. The data processing device may include, but is not limited to, devices such as an upper computer. In this embodiment, the service performance of the transportation infrastructure health monitoring system is mainly used to reflect whether each single parameter sensing measurement equipment in the transportation infrastructure monitoring system is operating normally and healthily.

In another optional embodiment, the service performance of the transportation infrastructure health monitoring system can be divided into the first level, the second level, and the third level. The first level can ensure that all measured data is consistent with the corresponding predicted data, that is, each single parameter sensing measuring equipment is operating normally; the second level can ensure that some single parameter sensing measuring equipment is operating normally; and the third level can ensure that all single parameter sensing measuring equipment is failure of operating.

In one or some other embodiments, the service performance of the transportation infrastructure health monitoring system can also be divided or determined through other forms, which will not be listed here for brevity.

In another optional embodiment, by processing and analyzing the measured data and the corresponding predicted data generated by each parameter sensing measurement equipment in the transportation infrastructure health monitoring system, it is easy to determine whether each parameter sensing measurement equipment has detection distortion or damage. When determining whether the parameter sensing measurement equipment has detection distortion or damage, specifically, it can be achieved by identifying the consistency between the predicted data and the measured data.

Furthermore, in one embodiment, a judgment threshold can be set in advance. If the difference in data consistency of the measured data is less than the judgment threshold, it is determined that the parameter sensing measurement equipment needs to be calibrated for detection distortion. If the difference in data consistency of the measured data is greater than or equal to the judgment threshold, it is determined that the parameter sensing measurement equipment is damaged and needs to be replaced or repaired.

In an optional embodiment, for parameter sensing measurement equipment that requires calibration, compensation or counterbalance can be performed based on predicted data. In another embodiment, when the parameter sensing measurement equipment is damaged, it can quickly locate the damaged parameter sensing measurement equipment to provide timely warning, so as to support equipment replacement, ensure the stable operation of the transportation infrastructure health monitoring system, and effectively prevent and avoid accidents.

By constructing a response model of external incentive and the corresponding road section in combination with the measured data obtained from the standard sensor, the method for evaluating the service performance of the transportation infrastructure health monitoring system provided by the present disclosure predicts the response data of the corresponding road section, and compares the response data with the actual data obtained from the transportation infrastructure health monitoring system to be evaluated, thereby achieving the evaluation and calibration of the current service performance of the transportation infrastructure health monitoring system to be evaluated.

The present disclosure not only saves manpower and material resources, but also improves the selectivity of external incentive by constructing response models for various external incentive and corresponding road sections, overcoming the load requirements in the current service performance evaluation of transportation infrastructure health monitoring system. At the same time, the method for evaluating the service performance of the transportation infrastructure health monitoring system provided by the present disclosure is an online measurement scheme, which can achieve timely data resource updates and corresponding system evaluation and calibration. The online measurement method does not need to close roads, which can effectively avoid traffic congestion and other related problems caused by closed roads.

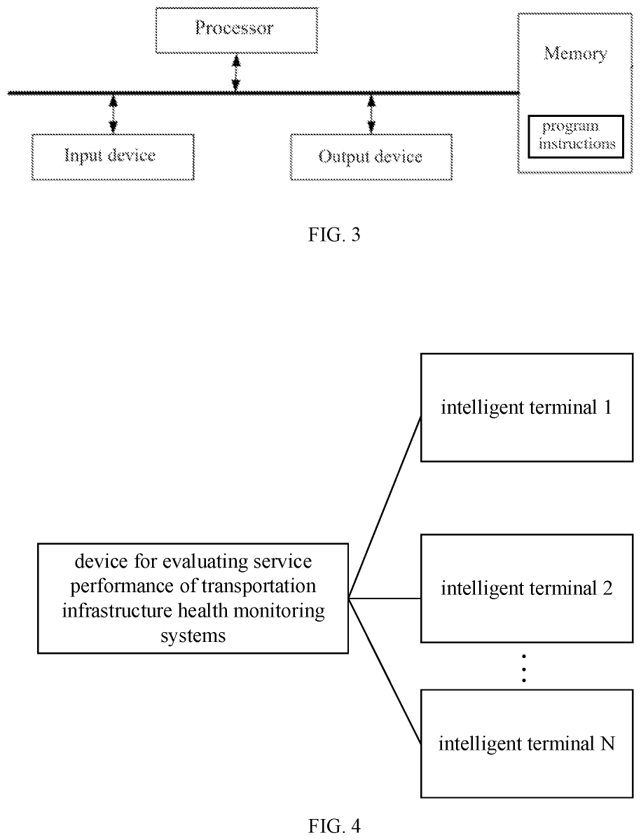

Please refer to FIG. 3, the present disclosure further provides a device for evaluating the service performance of transportation infrastructure health monitoring systems, including a processor, an input device, an output device, and a memory, wherein the processor, the input device, the output device, and the memory are interconnected; the memory is configured to store computer programs, the computer program includes program instructions, and the processor is configured to call the program instructions to execute steps of the method for evaluating service performance of transportation infrastructure health monitoring systems provided by the present disclosure. The device for evaluating the service performance of transportation infrastructure health monitoring systems provided by the present disclosure has a compact structure, stable performance, and can efficiently execute the method for evaluating the service performance of the transportation infrastructure health monitoring systems of the present disclosure, which to some extent improves the applicability and practical application ability of the present disclosure.

It should be understood that in embodiments of the present disclosure, the memory may include read-only memory and random-access memory, and provides instructions and data to the processor. Some part of the memory may also include non-volatile random-access memory. For example, memory can also store information related to device types.

The processor is used to run or execute operating systems, various software programs, and its own instruction set stored in internal memory, and to process data and instructions received from touch input devices or other external input channels to achieve various functions. The processors can include, but are not limited to, one or more of central processing units, general-purpose image processors, microprocessors, digital signal processors, field programmable gate arrays, and application specific integrated circuits. In some embodiments, the processor and the memory controller may be implemented on a single chip. In some other implementations, they can be implemented separately on independent chips.

The input devices maybe cameras, also known as computer cameras, computer eyes, and electronic eyes. Cameras are a type of video input device, as well as touch input devices such as digital keyboards or mechanical keyboards. The output device can include devices such as a display.

Another embodiment of the present disclosure illustrates a computer-readable storage medium that stores computer programs, and the computer programs includes program instructions. When the program instructions executed by a processor, cause the processor to execute the relevant steps of the method for evaluating the service performance of the transportation infrastructure health monitoring systems.

Wherein, the computer-readable storage medium may include cache, high-speed random-access memory, such as common double data rate synchronous dynamic random-access memory, and may also include non-volatile memory, such as one or more read-only memory, disk storage devices, flash memory devices, or other non-volatile solid-state memory devices such as optical disks, floppy disks, or data tapes.

Please refer to FIG. 4, the embodiments of the transportation infrastructure health monitoring and evaluation system shown in the present disclosure include: a transportation infrastructure health monitoring and evaluation device and an intelligent terminal. The transportation infrastructure health monitoring and evaluation device can include servers or server clusters, and the intelligent terminal can include one or more intelligent terminals. The transportation infrastructure health monitoring and evaluation devices can be connected through wireless or wired networks. Furthermore, the intelligent terminal may include, but not be limited to, mobile devices such as smartphones.

The transportation infrastructure health monitoring and evaluation device can perform any step including the implementation of the method for evaluating the service performance of the transportation infrastructure health monitoring systems of the present disclosure. In an optional embodiment, the transportation infrastructure health monitoring and evaluation device can also send the results of the service performance evaluation of the transportation infrastructure health monitoring system to the intelligent terminal, thereby playing a role in early warning.

Finally, it should be noted that the above embodiments are only used to illustrate the technical solution of the present disclosure, not limitations to the present disclosure. Although the present disclosure has been described in detail with reference to the aforementioned embodiments, ordinary skilled person in the art should understand that the technical solutions recorded in the aforementioned embodiments can be modified or some or all of the technical features in the technical solutions can be equivalently substituted. These modifications or substitutions do not separate the essence of the corresponding technical solutions from the scope of the various embodiments of the present disclosure, but should be covered within the scope of the claims and specifications of the present disclosure.

1. A method for evaluating service performance of transportation infrastructure health monitoring systems, comprising the following steps:
providing an external incentive and setting the external incentive within a road section monitored by the transportation infrastructure health monitoring system to be evaluated;
providing a standard sensor, and obtaining feedback data corresponding to the external incentive acting within the road section through the standard sensor;
constructing a predictive response model of the feedback data within the road section, and combining the predictive response model with the feedback data to obtain predicted data;
obtaining measured data through the transportation infrastructure health monitoring system to be evaluated;
conducting an evaluation and a calibration on the service performance of the transportation infrastructure health monitoring system to be evaluated based on the predicted data and the measured data;
providing the external incentive and setting the external incentive within the road section monitored by the transportation infrastructure health monitoring system to be evaluated, comprising the following steps:
providing a vehicle with four degrees of freedom as the external incentive;
setting a motion speed of the vehicle with four degrees of freedom;
placing the vehicle with four degrees of freedom within the road section monitored by the transportation infrastructure health monitoring system to be evaluated, wherein the vehicle with four degrees of freedom travels at a constant speed at the motion speed;
constructing the predictive response model of the feedback data within the road section, and combining the predictive response model with the feedback data to obtain the predicted data, comprising the following steps:
constructing a vehicle vertical motion equation based on an interaction between the vehicle with four degrees of freedom and the road section;
constructing a vehicle vertical displacement equation by utilizing the vehicle vertical motion equation;
solving the vehicle vertical displacement equation to obtain a relationship between a vehicle vertical displacement and a bridge modal displacement;
obtaining a relationship between a vehicle vertical acceleration and a bridge oscillation frequency response by utilizing the relationship between the vehicle vertical displacement and the bridge modal displacement;
obtaining the predictive response model by utilizing the relationship between the vehicle vertical acceleration and the bridge oscillation frequency response;
obtaining the measured data through the transportation infrastructure health monitoring system to be evaluated, comprising the following steps:
obtaining an actual measurement data sequence through the transportation infrastructure health monitoring system to be evaluated;
generating a first-order measurement data sequence by utilizing the actual measurement data sequence;
building a prediction coefficient model based on the actual measurement data sequence and the first-order measurement data sequence, and using the prediction coefficient model to obtain the prediction coefficient;
generating a first-order measurement prediction sequence by combining the first-order measurement data sequence with the corresponding prediction coefficient;
generating a raw data prediction sequence by combining the first-order measurement prediction sequence with the actual measurement data sequence;
obtaining measured data through the transportation infrastructure health monitoring system to be evaluated, further comprising correcting the first-order measurement prediction sequence;
wherein correcting the first-order measurement prediction sequence comprises the following steps:
combining the raw data prediction sequence with the actual measurement data sequence to obtain a basic absolute error sequence;
generating a first-order error data sequence by utilizing the basic absolute error sequence;
building an error prediction coefficient model based on the basic absolute error sequence and the first-order error data sequence, and utilizing the error prediction coefficient model to obtain an error prediction coefficient;
correcting the first-order measurement prediction sequence by utilizing the error prediction coefficient and the basic absolute error sequence, and the corrected first-order measurement prediction sequence satisfies a following model: [symbol] ¹={ [symbol] ¹(1), [symbol] ¹(2), . . . , [symbol] ¹(G)}, wherein
$${1}^{} ( i ) = [ {x}^{0} ( 1 ) - \frac{b}{a} ] {e}^{- a ( i - 1 )} + \frac{b}{a} + ( - {a}_{ε} ) [ {ε}^{0} ( i ) - \frac{{b}_{ε}}{{a}_{ε}} ] {e}^{- {a}_{ε} ( i - 1 )} ,$$ [symbol]
¹ denotes the corrected first-order measurement prediction sequence, i=1, 2, . . . , G, [symbol] ¹(i) denotes the i-th sample data in the corrected first-order measurement prediction sequence, x⁰(1) denotes first sample data in the actual measurement data sequence, a denotes a first prediction coefficient, b denotes a second prediction coefficient, e denotes a natural constant, a_{ε} denotes a first error prediction coefficient, b_{ε} denotes a second error prediction coefficient, and ε⁰(i) denotes the i-th absolute error data of the basic absolute error sequence.

2. The method for evaluating service performance of the transportation infrastructure health monitoring systems according to claim 1, wherein the predictive response model satisfies the following formula:
$${a}_{c} = {\sum }_{n} \frac{{Δ}_{stn}}{( 1 - {S}_{n}^{2} )} \{ {( 2 D )}^{2} cos 2 D +$$
$${S}_{n} [ {( {ω}_{bn} - D )}^{2} cos ( {ω}_{bn} - D ) t - {( {ω}_{bn} + D )}^{2} cos ( {ω}_{bn} - D ) t ] \} ,$$
wherein a_{c} denotes the vehicle vertical acceleration, Δₛₜₙ denotes a static load displacement, Sₙ denotes a vehicle dynamic response coefficient parameter, n=1, 2, 3, . . . , n denotes the number of orders of the bridge frequency,
$$D = \frac{n π v}{L} ,$$
ν a vehicle speed without damping, L denotes a length of a road section of a bridge,
$${ω}_{bn} = \frac{{n}^{2} {π}^{2}}{{L}^{2}} \sqrt{\frac{EI}{\overline{m}}} ,$$
ω_{bn} is the n-th order frequency of bridge oscillation, m̅ denotes unit mass of the bridge, E denotes an elastic modulus of the bridge, I denotes a moment of inertia of a cross section of the bridge, and t denotes a vehicle running time.

3. The method for evaluating service performance of the transportation infrastructure health monitoring systems according to claim 1, wherein the raw data prediction sequence satisfies the following model: \hat{X}⁰={\hat{x}⁰(1), \hat{x}⁰ (2), . . . , \hat{x}⁰ (G)}, wherein, \hat{X}⁰ denotes the raw data prediction sequence, G denotes a total number of sample data in the raw data prediction sequence, \hat{x}⁰(1)=\hat{x}⁰(1), \hat{x}⁰(i)=\hat{x}¹(i)−\hat{x}¹(i−1), \hat{x}⁰(1) denotes first sample data in the raw data prediction sequence, x⁰(1) denotes first sample data in the actual measurement data sequence, \hat{x}⁰(i) denotes the i-th sample data in the raw data prediction sequence, \hat{x}¹(i) denotes the i-th sample data in the first-order measurement prediction sequence, and \hat{x}¹(i−1) denotes the i−1-th sample data in the first-order measurement prediction sequence.

4. The method for evaluating service performance of the transportation infrastructure health monitoring system according to claim 1, wherein obtaining the measured data through the transportation infrastructure health monitoring system to be evaluated, further comprising the following steps:
building a prediction error model, and utilizing the prediction error model to obtain a prediction error of sample data in the raw data prediction sequence;
setting a prediction error threshold, and utilizing the prediction error threshold in combination with the prediction error to correct the sample data in the raw data prediction sequence.

5. A device for evaluating service performance of transportation infrastructure health monitoring systems, comprising a processor, an input device, an output device, and a memory, wherein the processor, the input device, the output device, and the memory are interconnected; the memory is configured to store computer programs, the computer program comprises program instructions, and the processor is configured to call the program instructions to execute the method for evaluating service performance of transportation infrastructure health monitoring system according to claim 1.
